(19) United States
(12) Patent Application Publication
(10) Pub. No.: US 2010/0005112 A1
(43) Pub. Date: Jan. 7, 2010

(54) HTML FILE CONVERSION

(75) Inventor: Rui Dinis Gomes Amorim Nogueira, Neustadt an der Weinstrasse (DE)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 12/165,870

(22) Filed: Jul. 1, 2008

(51) Int. Cl. G06F 17/30

(52) U.S. Cl. 707/101; 707/E17.009

(57) ABSTRACT

A computer-implemented method for converting a hypertext markup language (HTML) file to a new file format may include cleaning a source hypertext markup language (HTML) file to produce a modified HTML file, parsing the modified HTML file using one or more rules to mark content within the modified HTML file, and exporting the marked content from the modified HTML file into a template for a new file format.

### TECHNICAL FIELD

This description relates to conversion of hypertext markup language (HTML) files to other file structures.

### BACKGROUND

The migration of web pages from one format to another format may be a tedious and manually intensive process. The new file format and/or new file structure may not enable the content from the old format and old file structure to be easily transferred. A user may not be able to cut and paste the content from the old format into the new format. Each of the web pages in the old format may need to be manually re-typed into the new page format.

For example, a large number of hypertext markup language (HTML) pages may need to be migrated to a system such as a corporate portal system, where the file format and/or file structure of the corporate portal system may be different from the HTML pages. The migration of the HTML pages to the corporate portal system may be a tedious and manually intensive process.

### SUMMARY

In one general aspect, a computer-implemented method for converting a hypertext markup language (HTML) file to a new file format may include cleaning a source hypertext markup language (HTML) file to produce a modified HTML file, parsing the modified HTML file using one or more rules to mark content within the modified HTML file, and exporting the marked content from the modified HTML file into a template for a new file format.

Implementations may include one or more of the following features. For example, cleaning the source HTML file may include cleaning the source HTML file to produce the modified HTML file, where the modified HTML file conforms to an extensible HTML file format. Parsing the modified HTML file may include parsing the modified HTML file using one or more rules to mark content within the modified HTML file with one or more variables to distinguish between different types of the content. The computer-implemented method may further include defining the template for the new file format.

Exporting the marked content may include recursively looping through the marked content and populating the template with the marked content in the new file format. Parsing the modified HTML file may include creating a variable having multiple elements, where each of the elements represents a section of the marked content. Exporting the marked content may include recursively looping over the variable and populating the template with each of the elements from the variable.

In another general aspect, a computer program product for converting an HTML file to a new file format may be tangibly embodied on a computer-readable medium and may include executable code that, when executed, is configured to cause a hypertext markup language converter to clean a source hypertext markup language (HTML) file to produce a modified HTML file, to parse the modified HTML file using one or more rules to mark content within the modified HTML file, and to export the marked content from the modified HTML file into a template for a new file format.

Implementations may include one or more of the following features. For example, the hypertext markup language converter may be further configured to clean the source HTML file to produce the modified HTML file, where the modified HTML file conforms to an extensible HTML file format. The hypertext markup language converter may be further configured to parse the modified HTML file using one or more rules to mark content within the modified HTML file with one or more variables to distinguish between different types of the content. The hypertext markup language converter may be further configured to define the template for the new file format.

The hypertext markup language converter may be further configured to recursively loop through the marked content and populate the template with the marked content in the new file format. The hypertext markup language converter may be further configured to create a variable having multiple elements, where each of the elements represents a section of the marked content. The hypertext markup language converter may be further configured to recursively loop over the variable and populate the template with each of the elements from the variable.

In another general aspect, a system may include a cleaner module that is arranged and configured to clean a source hypertext markup language (HTML) file to produce a modified HTML file, a parser module that is arranged and configured to parse the modified HTML file using one or more rules to mark content within the modified HTML file, and a template filler module that is arranged and configured to export the marked content from the modified HTML file into a template for a new file format.

Implementations may include one or more of the following features. For example, the cleaner module may be further arranged and configured to clean the source HTML file to produce the modified HTML file, where the modified HTML file conforms to an extensible HTML file format. The parser module may be further arranged and configured to parse the modified HTML file using one or more rules to mark content within the modified HTML file with one or more variables to distinguish between different types of the content.

The template filler module may be further arranged and configured to recursively loop through the marked content and populate the template with the marked content in the new file format. The parser module may be further arranged and configured to create a variable having multiple elements, where each of the elements represents a section of the marked content. The template filler module may be further arranged and configured to recursively loop over the variable and populate the template with each of the elements from the variable.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a system for converting an HTML file to a new file format.

FIG. 2 is an exemplary illustration of a source HTML page.

FIG. 3 is an exemplary illustration of the HTML file of the source HTML page of FIG. 2.

FIG. 4 is an exemplary illustration of a modified HTML page.

FIGS. 5A and 5B are exemplary illustrations of the modified HTML file of the modified HTML page of FIG. 4.

FIG. 6 is an exemplary illustration of a template.

FIGS. 7A and 7B are exemplary illustrations of a file in the new file format.

FIG. 8 is an exemplary flowchart illustrating example operations of the system of FIG. 1.

### DETAILED DESCRIPTION

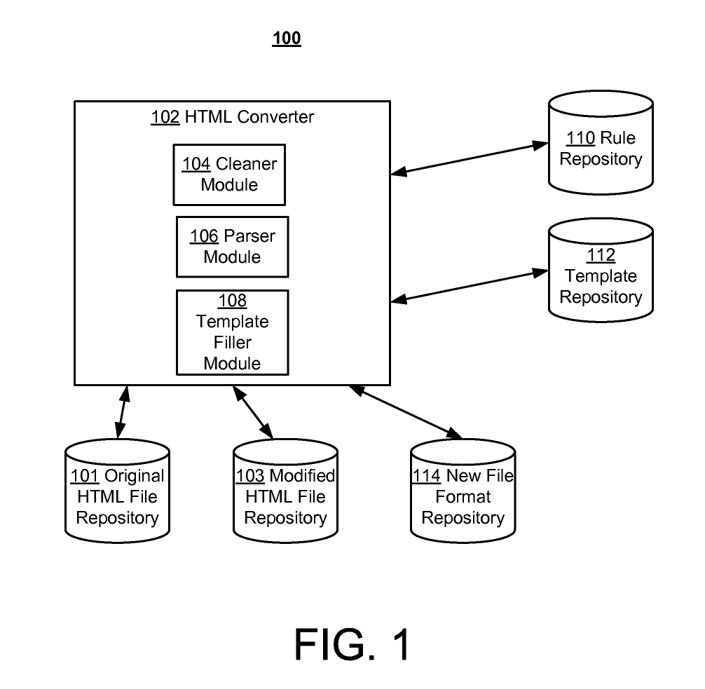

FIG. 1 is an exemplary block diagram of a system 100 for converting an HTML file to a new file format. The system 100 may include an HTML converter 102 having a cleaner module 104, a parser module 106 and a template filler module 108. The system 100 also may include an original HTML file repository 101, a modified HTML file repository 103, a rule repository 110, a template repository 112 and a new file format repository 114. The system 100 may be configured to convert automatically an HTML file to a new file having a different file format or different file structure.

Each of the repositories (e.g., the original HTML file repository 101, the modified HTML file repository 103, the rule repository 110, the template repository 112 and the new file format repository 114) may be any type of data store or database that is stored in any type of memory or storage device such as, for example, all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. Although illustrated as separate repositories, the repositories may be combined in any combination into fewer repositories that may be partitioned to separate the data.

The original HTML file repository 101 may be configured to store one or more source HTML files. For example, the original HTML file repository 101 may store the source HTML files for a website to be displayed on an intranet and/or the Internet. The HTML converter 102 may be arranged and configured to convert the source HTML files into files having one or more different formats for display on an intranet and/or the Internet. The HTML converter 102 may be configured to convert the source HTML files into new file formats without user intervention in the conversion process.

In one exemplary implementation, the HTML converter 102 may be used to migrate a set of HTML pages from one system to another system that uses a different page format other than HTML and/or a different file structure. The HTML converter 102 may be configured to automatically convert the set of HTML pages from the first system to the different formatted pages of the other system. For instance, the first system may be a corporate intranet having a set of HTML pages and the new system may be a corporate portal that uses a set of pages that are in a format other than HTML such as, for example, an extensible markup language (XML) format, standard generalized markup language (SGML) format, DocBook format and other format.

The HTML converter 102 may include the cleaner module 104, the parser module 106 and the template filler module 108. The HTML converter 102 may be configured to communicate and access the original HTML file repository 101, the modified HTML file repository 103, the rule repository 110, the template repository 112 and the new file format repository 114.

The cleaner module 104 may be configured to clean a source HTML file to produce a modified HTML file. The cleaner module 104 may check the source HTML file against a document type definition (DTD) file to validate the source HTML file and to determine whether or not the source HTML file is valid and, if not valid, to identify and correct any syntax errors. The cleaner module 104 may conform the source HTML file such that the modified HTML file conforms to an extensible HTML (XHTML) file format.

In one exemplary implementation, the cleaner module 104 may include a validator tool such as, for example, HTML Tidy, which may be found at http://tidy.sourceforge.net. The result of the cleaner module 104 may be the modified HTML file, which may be stored in the modified HTML file repository 103. In other exemplary implementations, the cleaner module 104 may include other validator-type tools.

The cleaner module 104 may be configured to determine whether or not the source HTML file may be corrected to fix syntax and other errors. If the cleaner module 104 determines that the source HTML file may not be cleaned, then the cleaner module 104 may mark the source HTML file as not being eligible for automatic conversion by the HTML converter 102 to the new file format. A source HTML file that has been marked as not being eligible for conversion to the new file format may need to be manually converted to the new file format by a user.

The parser module 106 may be configured to parse the modified HTML file using one or more rules to mark content within the modified HTML file. For example, the parser module 106 may be configured to access the modified HTML file from the modified HTML file repository 103 or to receive the modified HTML file directly from the cleaner module 104. The parser module 106 may access the rule repository 110 to retrieve one or more rules to be applied to the modified HTML file. The parser module 106 may parse the modified HTML file by searching through the modified HTML file and applying the rules to the modified HTML file to create a structured format. The search may be a one-time pass through the modified HTML file or the search may be a recursive search that applies the rules as it loops through the modified HTML file more than once.

The rule repository 110 may include the one or more rules that are used by the parser module 106. The rules may be structured or formatted to identify one or more sections of the modified HTML file. The rules make it possible to automatically distinguish between different parts of the modified HTML file. For example, a rule may be defined to distinguish between information such as the headline of an HTML page and the content related to the headline.

In one exemplary implementation, the rule may be defined to search for all tags in the HTML file with the format <hx>, where x is the headline level, and the information between two of these tags is content. The parser module 106 may apply the rule to the modified HTML file and generate one or more variables, where each of the variables may include one or more elements with each of the elements representing a headline and corresponding content. The variable created by the parser module 106 may be a hash variable. The variable may store information using multiple elements (e.g., n elements), where the elements correspond to a section of information from the modified HTML file. Each element may have a defined set of properties. The parser module 106 may be configured to apply the rules and mark the content using the variables and elements of the variables to represent the marked content of the modified HTML file.

In other exemplary implementations, other rules may be defined and stored in the rules repository 110. The rules may be based on the particular type of formatting of the particular source HTML file. The selection of a specific rule may be based on the format of the source HTML file. For example, other rules may be defined that are based on searching for the use of other types of HTML tags. A particular HTML file may use the bold tag to mark sections of content instead of or in addition to the headline tag. For instance, a rule may be defined to search for the bold tag and the information between two bold tags is the content.

In one exemplary implementation, the parser module 106 may use a common gateway interface (CGI) script to apply the rules and mark the content using the variables. The CGI script may be used to create a structure for the marked content in the modified HTML file.

The template filler module 108 may be configured to export the marked content from the modified HTML file into a template for a new file format. The template repository 112 may be configured to store one or more templates. The templates may be structured to correspond to a new file format and/or a new file structure. For example, the template may be configured to conform to an XML format, a DocBook format or other file format. Each template in the template repository 112 may correspond to a different file format or combination of file formats.

In one exemplary implementation, one system that uses an HTML file format may be migrated to another system that uses an XML file format such that the templates represent the XML file format that is used by the new system. The templates may include one or more markers or variables that correspond to the variables used by the parser module 106. The template filler module 108 may be configured to recursively loop through the marked content and populate the template with the marked content in the new file format. The template may be populated with the elements of the variables that represent the marked content and may be populated in the appropriate sections of the template using corresponding variables as placeholders. These placeholders in the template may be removed once the template has been populated.

The templates also may include other information in addition to the information that is being populated into the template. The result from the template filler module 108 is a file in a new format that includes the content from the source HTML file. The template filler module 108 may be configured to store the new file format in the new file format repository 114. The new file then may be used and uploaded to an intranet or the Internet.

In one exemplary implementation, the template filler module 108 may include a template filler tool. For example, the template filler module 108 may include a template filler tool such as a perl module called HTML-Template, which may be found at http ://search.cpan.org/˜samtregar/HTML-Template-2.6/Template.pm. In other exemplary implementations, the template filler module 108 may include and use other template filler tools.

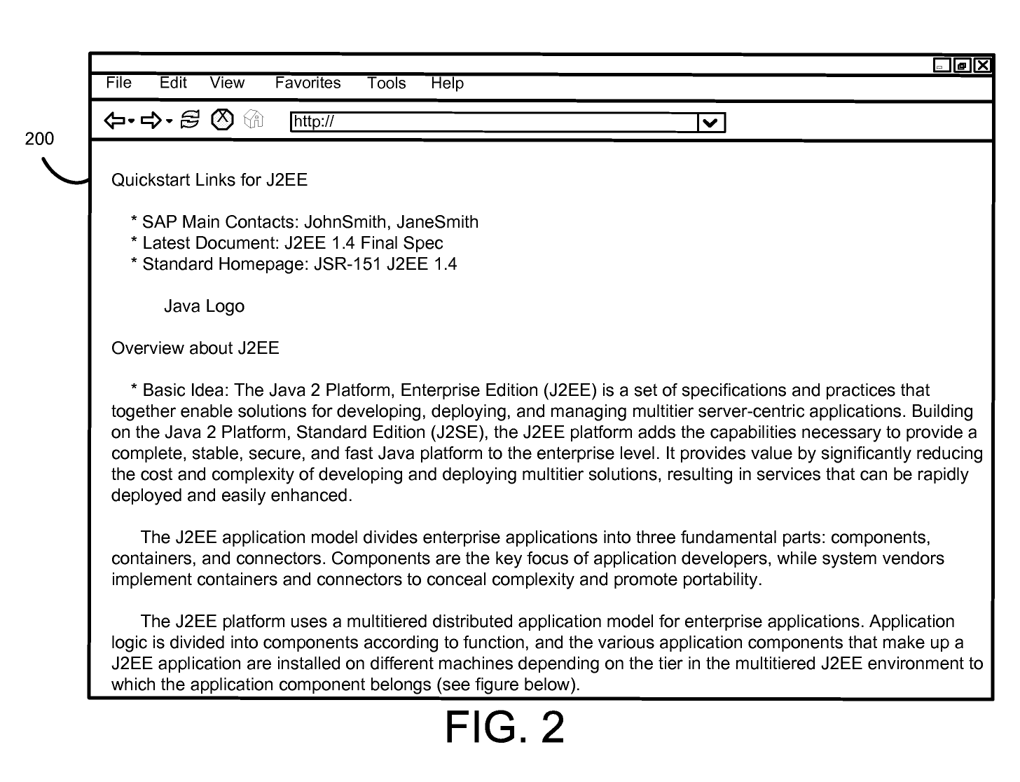

Referring to FIG. 2, an exemplary source HTML page 200 is illustrated, as viewed in a web browser. The source HTML page 200 may be stored in the original HTML file repository 101 and may be an excerpt from a corporate portal page.

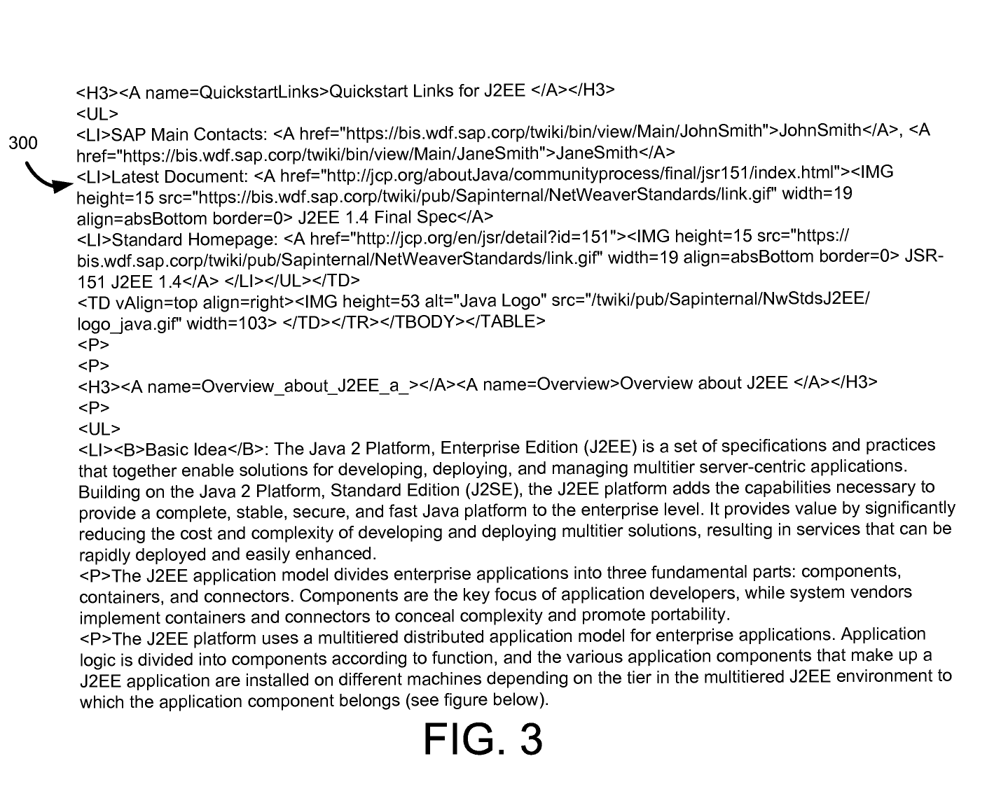

Referring to FIG. 3, an exemplary HTML source file 300 illustrated, where the HTML source file 300 includes the source code for the source HTML page 200 of FIG. 2. The HTML source file 300 illustrates a source HTML file that may be stored in the original HTML file repository 101.

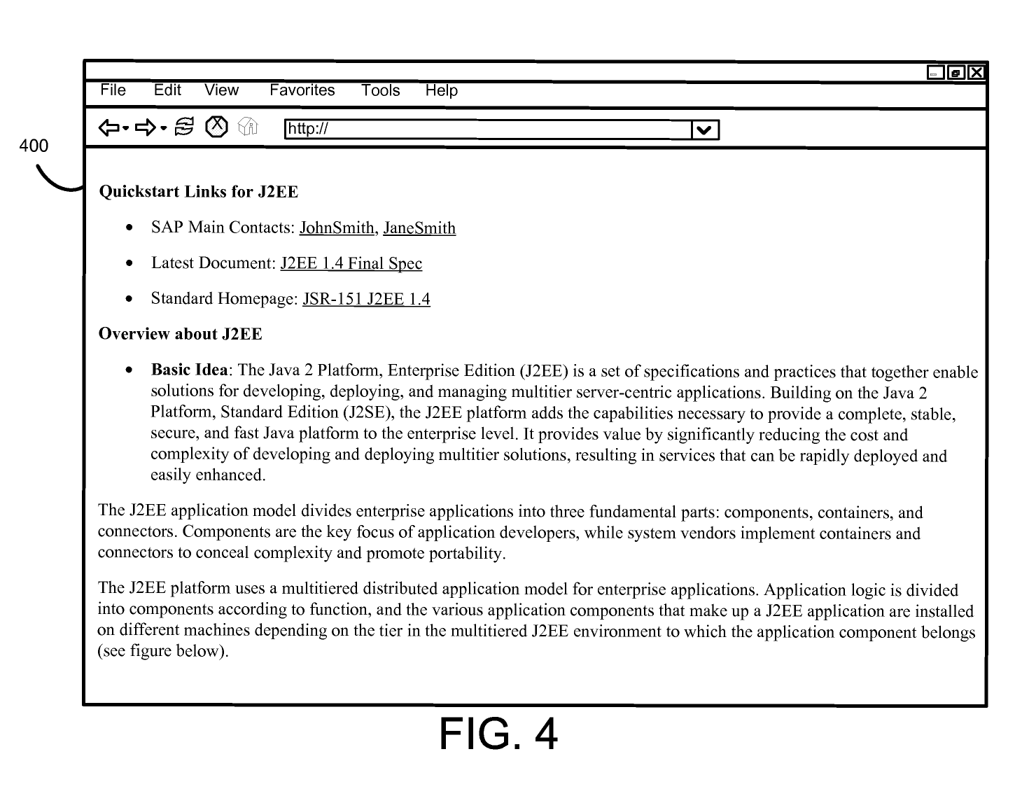

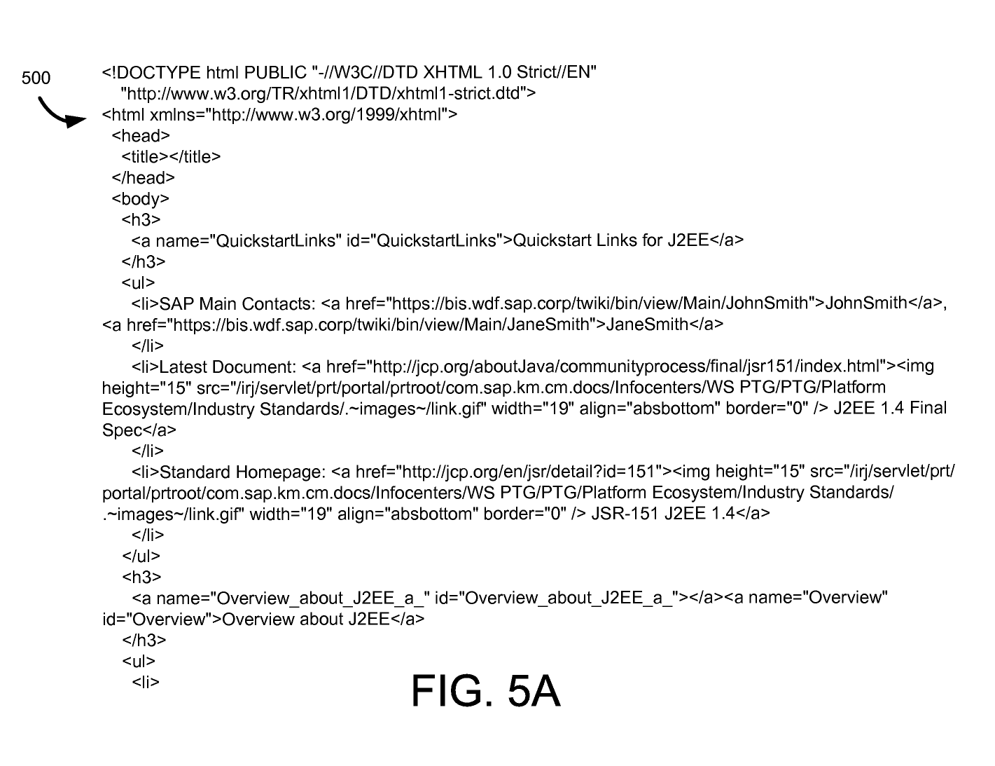

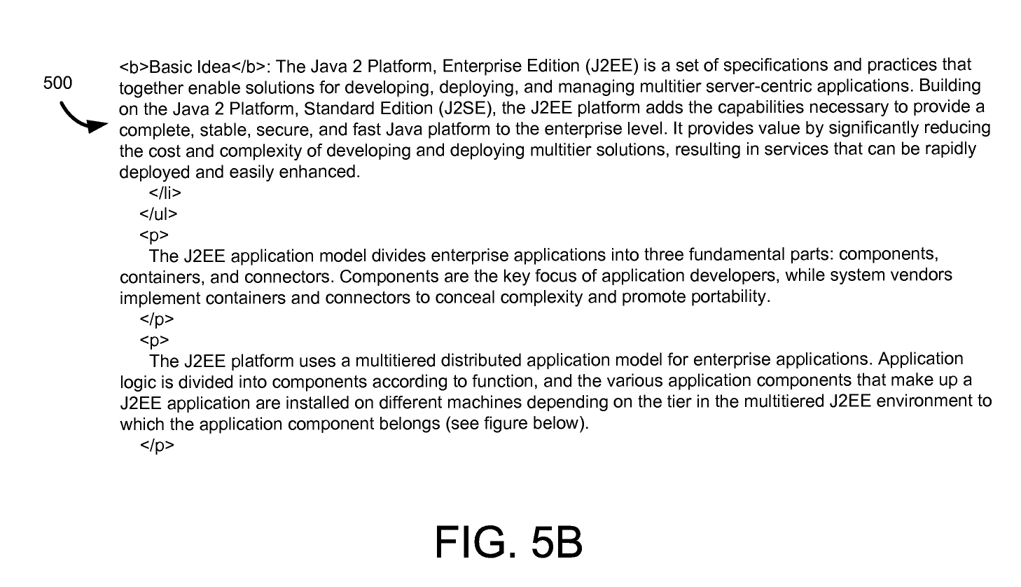

The HTML converter 102 may be used to convert the HTML source file 300 into to a new file format. As discussed above with respect to FIG. 1, the cleaner module 104 may be configured to clean the source HTML file 300 to produce a modified HTML file. Referring to FIG. 4, an exemplary modified HTML page 400 is illustrated, as viewed in a web browser. The content of the modified HTML page 400 is the same as the content as in the source HTML page 200 of FIG. 2. Referring also to FIGS. 5A and 5B, an exemplary modified HTML file 500 is illustrated, where the modified HTML file 500 includes the modified code for the modified HTML page 400. As one can see, the modified HTML file 500 is the result of the cleaner module 104 cleaning the source HTML file 300. The modified HTML file 500 may be stored, even if only temporary, in the modified HTML file repository 103.

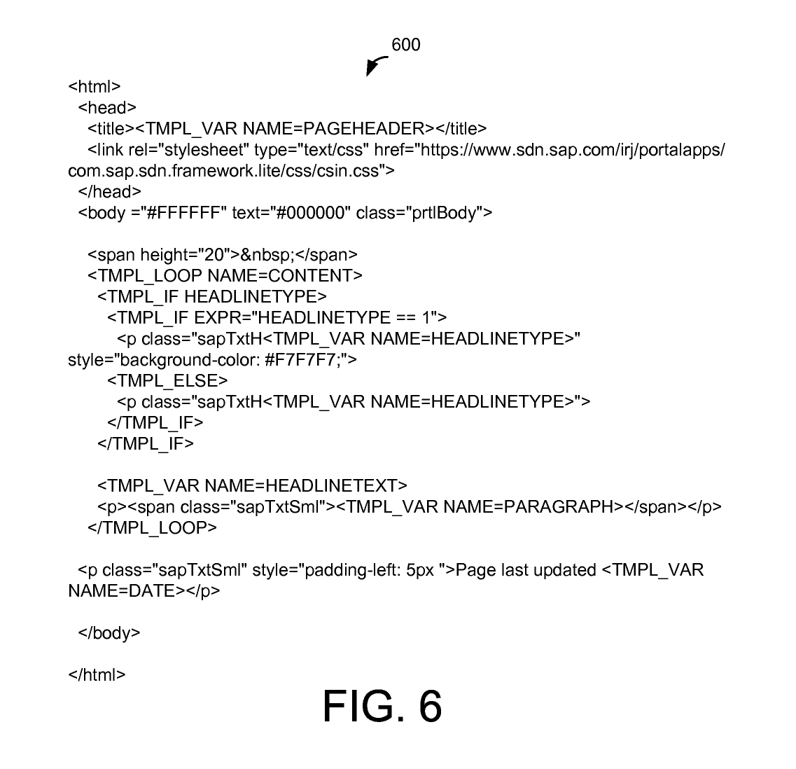

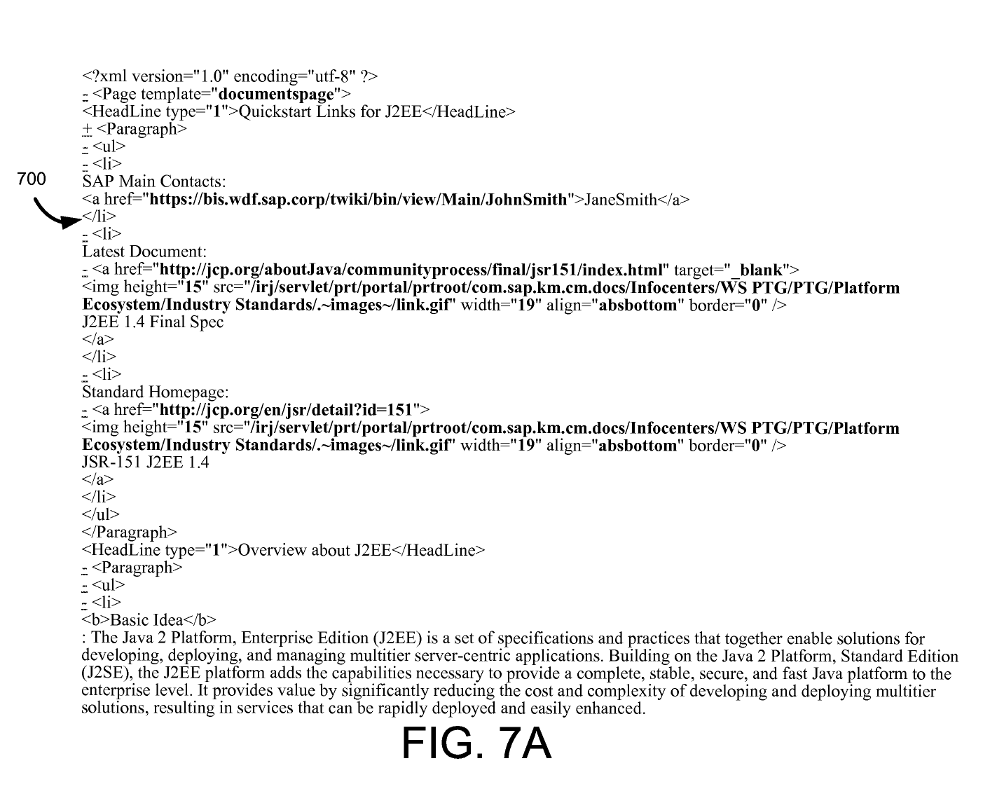

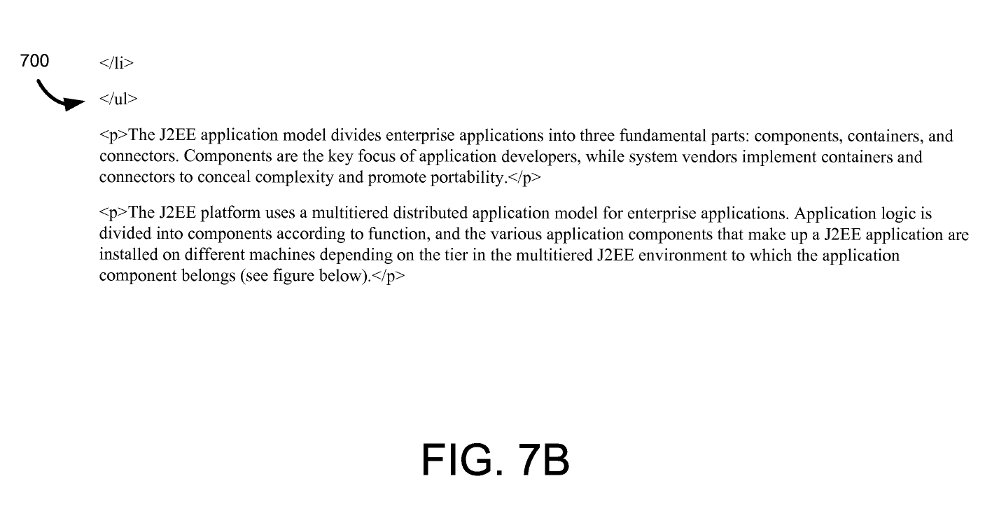

The parser module 106 may be configured to parse the modified HTML file 500 using one or more rules to mark content within the modified HTML file 500. Referring to FIG. 6, an exemplary template 600 may be used by the template filler module 108 to export the marked content from the modified HTML file 500 into the template 600 for a new file format. Referring to FIGS. 7A and 7B, an exemplary new file format 700 is illustrated, which may be stored in the new file format repository 114. The new file format 700, when viewed using a web browser, contains the same content from the source HTML page 200 with the difference being that the new file format 700 is an XML format (based on a specific DTD), whereas the source HTML page 200 was in an HTML file format 300.

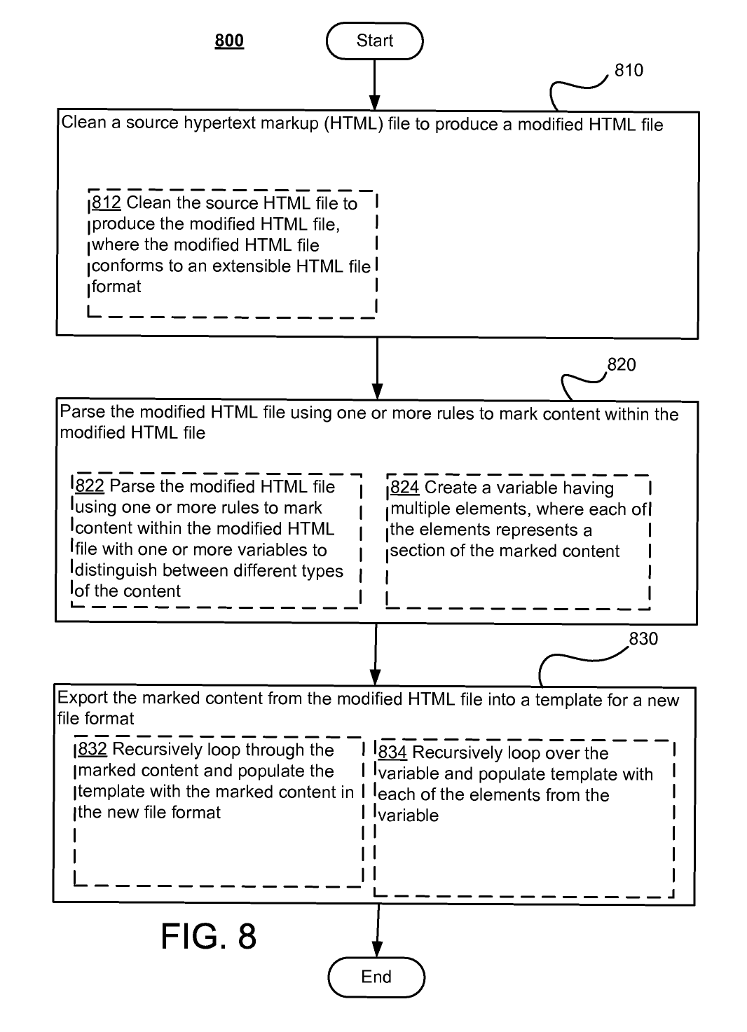

Referring to FIG. 8, a process 800 is illustrated for converting an HTML file to a new file format. The process 800 may include cleaning a source HTML file to produce a modified HTML file (810), parsing the modified HTML file using one or more rules to mark content within the modified HTML file (820), and exporting the marked content from the modified HTML file into a template for a new file format (830).

For example, the cleaner module 104 may be configured to clean the source HTML file 300 to produce the modified HTML file 500 (810). Cleaning the source HTML file also may include cleaning the source HTML file to produce the modified HTML file, where the modified HTML file conforms to an XHTML file format (812).

The parser module 106 may be configured to parse the modified HTML file 500 using one or more rules to mark content within the modified HTML file 500 (820). Parsing the modified HTML file also may include parsing the modified HTML file using one or more rules to mark content within the modified HTML file with one or more variables to distinguish between different types of the content (822). Parsing the modified HTML file also may include creating a variable having multiple elements, where each of the elements represents a section of the marked content (824).

The template filler module 108 may be configured to export the marked content from the modified HTML file 500 into a template 600 for a new file format 700 (830). Exporting the marked content also may include recursively looping through the marked content and populating the template with the marked content in the new file format (832). Exporting the marked content also may include recursively looping over the variable and populating the template with each of the elements from the variable (834).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for converting a hypertext markup language (HTML) file to a new file format, the computer-implemented comprising:
cleaning a source hypertext markup language (HTML) file to produce a modified HTML file;
parsing the modified HTML file using one or more rules to mark content within the modified HTML file; and
exporting the marked content from the modified HTML file into a template for a new file format.

2. The computer-implemented method as in claim 1 wherein cleaning the source HTML file includes cleaning the source HTML file to produce the modified HTML file, wherein the modified HTML file conforms to an extensible HTML file format.

3. The computer-implemented method as in claim 1 wherein parsing the modified HTML file includes parsing the modified HTML file using one or more rules to mark content within the modified HTML file with one or more variables to distinguish between different types of the content.

4. The computer-implemented method as in claim 1 further comprising defining the template for the new file format.

5. The computer-implemented method as in claim 1 wherein exporting the marked content includes recursively looping through the marked content and populating the template with the marked content in the new file format.

6. The computer-implemented method as in claim 1 wherein parsing the modified HTML file includes creating a variable having multiple elements, wherein each of the elements represents a section of the marked content.

7. The computer-implemented method as in claim 6 wherein exporting the marked content includes recursively looping over the variable and populating the template with each of the elements from the variable.

8. A computer program product for converting an HTML file to a new file format, the computer program product being tangibly embodied on a computer-readable medium and including executable code that, when executed, is configured to cause a hypertext markup language converter to:
clean a source hypertext markup language (HTML) file to produce a modified HTML file;
parse the modified HTML file using one or more rules to mark content within the modified HTML file; and
export the marked content from the modified HTML file into a template for a new file format.

9. The computer program product of claim 8 wherein the hypertext markup language converter is further configured to clean the source HTML file to produce the modified HTML file, wherein the modified HTML file conforms to an extensible HTML file format.

10. The computer program product of claim 8 wherein the hypertext markup language converter is further configured to parse the modified HTML file using one or more rules to mark content within the modified HTML file with one or more variables to distinguish between different types of the content.

11. The computer program product of claim 8 wherein the hypertext markup language converter is further configured to define the template for the new file format.

12. The computer program product of claim 8 wherein the hypertext markup language converter is further configured to recursively loop through the marked content and populate the template with the marked content in the new file format.

13. The computer program product of claim 8 wherein the hypertext markup language converter is further configured to create a variable having multiple elements, wherein each of the elements represents a section of the marked content.

14. The computer program product of claim 13 wherein the hypertext markup language converter is further configured to recursively loop over the variable and populate the template with each of the elements from the variable.

15. A system, comprising:
a cleaner module that is arranged and configured to clean a source hypertext markup language (HTML) file to produce a modified HTML file;
a parser module that is arranged and configured to parse the modified HTML file using one or more rules to mark content within the modified HTML file; and
a template filler module that is arranged and configured to export the marked content from the modified HTML file into a template for a new file format.

16. The system of claim 15 wherein the cleaner module is further arranged and configured to clean the source HTML file to produce the modified HTML file, wherein the modified HTML file conforms to an extensible HTML file format.

17. The system of claim 15 wherein the parser module is further arranged and configured to parse the modified HTML file using one or more rules to mark content within the modified HTML file with one or more variables to distinguish between different types of the content.

18. The system of claim 15 wherein the template filler module is further arranged and configured to recursively loop through the marked content and populate the template with the marked content in the new file format.

19. The system of claim 15 wherein the parser module is further arranged and configured to create a variable having multiple elements, wherein each of the elements represents a section of the marked content.

20. The system of claim 19 wherein the template filler module is further arranged and configured to recursively loop over the variable and populate the template with each of the elements from the variable.
